(19) United States
(12) Patent Application Publication
(10) Pub. No.: US 2016/0177129 A1
(43) Pub. Date: Jun. 23, 2016

(54) COMPOSITIONS AND METHODS FOR PREPARING LIQUID-REPELLENT ARTICLES

(71) Applicants: Thomas McCarthy, Amherst, MA (US); Liming Wang, Amherst, MA (US)

(72) Inventors: Thomas McCarthy, Amherst, MA (US); Liming Wang, Amherst, MA (US)

(21) Appl. No.: 14/976,381

(22) Filed: Dec. 21, 2015

Related U.S. Application Data
(60) Provisional application No. 62/095,990, filed on Dec. 23, 2014.

(51) Int. Cl. C09D 183/04; B05D 1/02; B05D 1/28; C03C 17/30

(52) U.S. Cl. CPC C09D 183/04; C03C 17/30; B05D 1/02; B05D 1/28; C03C 2217/76

(57) ABSTRACT

A composition for preparing a liquid-repellent surface includes a silicon-containing compound comprising units of the formula

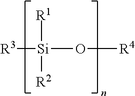

wherein R¹, R², R³, and R⁴ are defined herein. The composition further includes a multifunctional silane having at least two hydrolyzable groups, and an acid comprising a mineral acid, an organic acid, or a combination thereof. An article including a coating including the composition disposed on a surface of the article, and a method of preparing a liquid-repellent article are also disclosed.

### BACKGROUND OF THE INVENTION

Liquid repellency of a surface is an important property and has a wide range of potential applications in many areas, such as spontaneous droplet removal, antifouling surfaces, anti-icing surfaces, and the like. Methods to modify surface water repellency, especially of glass surfaces and other inorganic oxide surfaces, have been the subject of intensive research and development. Among them, dialkylsiloxanes (e.g., poly(dimethylsiloxane) (PDMS)) and dialkyldialkoxylsilane have proven to be active components in the preparation of non-stick and liquid repellent surfaces. See, e.g., U.S. Pat. No. 3,579,540 to Ohlhausen et al., which describes a composition comprising PDMS with a mineral acid for providing water repellency of flat substrates. Such a composition has proven useful to modify car windshields to make them water repellent and remain clear during raining (e.g., like a windshield wiper), and is known as Rain-X®. In U.S. Pat. No. 3,998,643 to Liddle et al., a composition is described including PDMS or dialkyldialkoxylsilane with a mineral acid and hydrofluoric acid, which can provide a clear view to drivers when coated on the windshield. Similarly, European Patent No. 0 565 743 B1 describes a composition including dialkyldialkoxylsilane with an acid for modification of glass substrates having good water repellent properties. Although coating a surface with PDMS, or a dialkyldialkoxylsilane in the presence of an acid represents a practical and efficient approach to render a substrate water repellent, the coatings described above are not very durable in water at high temperature (e.g., in a car wash), and when exposed to ionic impurities (e.g., on a salt-treated road). Also, a small amount of acid residue in the coating can corrode the coating quickly in air at elevated temperatures.

Accordingly, there remains a need in the art for an improved composition to overcome the above-described drawbacks, and provide durable liquid-repellent articles.

### BRIEF SUMMARY OF THE INVENTION

One embodiment is a composition for preparing a liquid-repellant surface comprising a silicon-containing compound comprising units of the formula

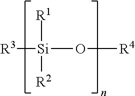

wherein R¹ and R² are independently at each occurrence a substituted or unsubstituted C₁-C₆ alkyl group or a substituted or unsubstituted C₆-C₁₂ aryl group; R³ is a halogen, a hydroxyl, a substituted or unsubstituted C₁-C₆ alkyl group or a hydrolyzable group; R⁴ is hydrogen or a substituted or unsubstituted C₁-C₆ alkyl group or a substituted or unsubstituted C₆-C₁₂ aryl group; and n is 1 to 1500; a multifunctional silane having at least two hydrolyzable groups; and an acid comprising a mineral acid, an organic acid, or a combination thereof

Another embodiment is an article comprising a coating comprising the composition for preparing a liquid-repellant surface, wherein at least a portion of the multifunctional silane has reacted with at least a portion of the silicon-containing compound.

Also disclosed is a method of preparing a liquid-repellent article, the method comprising applying the composition for preparing a liquid-repellant surface to a surface of a substrate to form a coating.

These and other embodiments are described in detail below.

### BRIEF DESCRIPTION OF THE DRAWINGS

The following Figures are exemplary embodiments.

FIG. 1A shows the advancing (squares) and receding (circles) contact angles for substrates coated with the composition according to Comparative Example 1 after heating at 75° C. for a selected time.

FIG. 1B shows the change in the thickness of a coating prepared from the composition of Comparative Example 1 with heating time at 75° C.

FIG. 2A shows the advancing (squares) and receding (circles) contact angles for substrates coated with the composition according to Comparative Example 2 after heating at 75° C. for a selected time.

FIG. 2B shows the change in the thickness of a coating prepared from the composition of Comparative Example 2 with heating time at 75° C.

FIG. 3A shows the advancing (squares) and receding (circles) contact angles for substrates coated with the composition according to Example 1 after heating at 75° C. for a selected time.

FIG. 3B shows the thickness of a coating prepared from the composition of Example 1 with heating time at 75° C.

FIG. 4A shows the advancing (squares) and receding (circles) contact angles for substrates coated with the composition according to Comparative Example 3 after heating at 75° C. for a selected time.

FIG. 4B shows the thickness of a coating prepared from the composition of Comparative Example 3 with heating time at 75° C.

FIG. 4C shows the advancing (squares) and receding (circles) contact angles for substrates coated with the composition according to Example 2 after heating at 75° C. for a selected time.

FIG. 4D shows the thickness of a coating prepared from the composition of Example 2 with heating time at 75° C.

FIG. 4E shows the advancing (squares) and receding (circles) contact angles for substrates coated with the composition according to Example 3 after heating at 75° C. for a selected time.

FIG. 4F shows the thickness of a coating prepared from the composition of Example 2 with heating time at 75° C.

### DETAILED DESCRIPTION OF THE INVENTION

The inventors hereof have discovered that a silicon-containing composition for rendering a surface liquid repellent can be improved by incorporating a multifunctional silane. The compositions can advantageously be used to prepare various coated articles, wherein the coatings have exceptional hydrolytic and thermal stability.

The composition for preparing a liquid-repellent surface comprises a silicon-containing compound. The silicon-containing compound comprises units of the formula

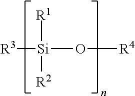

wherein R¹ and R² are independently at each occurrence a substituted or unsubstituted C₁-C₆ alkyl group or a substituted or unsubstituted C₆-C₁₂ aryl group; R³ is a halogen, a hydroxyl, a substituted or unsubstituted C₁-C₆ alkyl group, or a hydrolyzable group; R⁴ is hydrogen or a substituted or unsubstituted C₁-C₆ alkyl group or a substituted or unsubstituted C₆-C₁₂ aryl group; and n is 1 to 1500. As used herein, the term “hydrolyzable group” refers to a group or moiety that is cleavable or removable from the atom to which it is bonded by action of liquid water having a pH of 1 to 10 under conditions of atmospheric pressure. Hydrolysis of a hydrolyzable group can produce groups capable of undergoing a condensation reaction, for example, hydroxysilyl groups (e.g., a monovalent moiety or group comprising a silicon atom directly bonded to a hydroxyl group). Hydrolyzable groups can include halogen, alkoxyl, acyloxyl, aryloxyl, polyalkyleneoxyl, and combinations thereof.

In some embodiments, R³ is a hydrolyzable group comprising a C₁-C₆ alkoxyl group. In some embodiments, R⁴ is a C₁-C₆ alkyl group. In some embodiments, n is 1. For example, in some embodiments, R¹ and R² are each methyl, R³ is methoxyl, and R⁴ is methyl, and the silicon-containing compound is dimethyldimethoxysilane.

In some embodiments, the silicon-containing compound is a silicon-containing polymer, for example a polysiloxane having the above formula wherein n is greater than 1 to 1500, for example, 10 to 1000, for example, 10 to 800, for example, 10 to 500, for example 10 to 250, for example, 10 to 150. Accordingly, in some embodiments, the polysiloxanes can have a molecular weight of about 1000 to 10,000 daltons (Da). In an embodiment, n is about 125. Polysiloxanes can be linear, branched, or cyclic. In some embodiments, the polysiloxanes have the above formula wherein R¹ and R² are independently at each occurrence a substituted or unsubstituted C₁-C₆ alkyl group or C₆-C₁₂ aryl group, R³ is a hydrolyzable group comprising a C₁-C₆ alkoxyl group, and R⁴ is a C₁-C₆ alkyl group. In an embodiment, R¹ and R² are methyl, R³ is methoxyl, R⁴ is methyl, and n is 10 to 250. For example, the silicon-containing compound can be a polydimethylsiloxane, for example a dimethoxyl-terminated polydimethylsiloxane. In some embodiments, the composition excludes silsesquioxanes, polysesquioxanes, and combinations thereof

The compositions of the present disclosure further comprise a multifunctional silane. The multifunctional silane preferably has at least two hydrolyzable groups. For example, the multifunctional silane can be of the formula X₃₋ₘRₘSiR′SiRₘX₃₋ₘ, X₃₋ₘRₘSiR′NHR′SiRₘX₃₋ₘ, X₃₋ₘRₘSiR′OR′SiRₘX₃₋ₘ, X₃₋ₘRₘSiR′SₚR′SiRₘX₃₋ₘ, X₃₋ₘRₘSiR′SiRₘX₂₋ₘR′SiRₘX₃₋ₘ, SiX₄, or RSiX₃, wherein m is 0, 1, or 2, and p is 1, 2, 3, 4, 5, 6, 7, or 7. Each occurrence of R is independently a substituted or unsubstituted C₁-C₆ alkyl group or a substituted or unsubstituted C₆-C₁₂ aryl group, and each occurrence of X is independently a hydroxyl or a hydrolysable group comprising a halogen or a C₁-C₆ alkoxyl group; and each occurrence of R′ is independently a divalent substituted or unsubstituted C₁-C₁₂ alkyl group, a divalent substituted or unsubstituted C₁-C₁₂ alkenyl group, or a divalent substituted or unsubstituted C₁-C₁₂ alkynyl group. A combination of one or more silanes having any of the above-described formulas can also be used.

The multifunctional silane can be, for example, tetraethoxysilane, bis(triethoxysilyl)methane, bis(triethoxysilyl)ethane, 1,6-bis(trimethoxysilyphexane, bis(trimethoxysilylpropyl)amine, bis[3-(triethoxysily0propyl]disulfide, bis[3-(triethoxysily0propyl]tetrasulfide, (3-glycidoxypropyl)trimethoxysilane, bis(triethoxysilyl)ethylene, 1,4-bis(trimethoxysilylethyl)benzene, bis(trimethoxysilylpropyl)urea, tris[3-(trimethoxysilyl)propyl]isocyanurate, 1,1-bis(trimethoxysilylmethypethylene, methyltrimethoxysilane, bis(methyldimethoxysilyl)ethane, 1-(triethoxysilyl)-2-(diethoxymethylsilypethane, octaethoxy-1,3,5-trisilapentane, or a mixture thereof. In some embodiments, the multifunctional silane comprises dimethyldimethoxysilane, dimethyldiethoxysilane, methyltrimethoxysilane, tetraethoxysilane, bis(methyldimethoxysilyl)ethane, 1-(triethoxysilyl)-2-(diethoxymethylsilypethane, bis(triethoxysilyl)ethane, octaethoxy-1,3,5-trisilapentane, or a mixture thereof. In some embodiments, the multifunctional silane comprises methyltrimethoxysilane, 1-(triethoxysilyl)-2-(diethoxymethylsilypethane, bis(triethoxysilyl)ethane, or a combination thereof.

The silicon-containing compound and the multifunctional silane can be present in the composition in a mole ratio of 1:99 to 99:1, or 10:90 to 90:10, or 25:75 to 75:25, or 40:60 to 60:40. In some embodiments, the number of units of the silicon-containing compound (“n”) and the hydrolyzable groups of the multifunctional silane are present in the composition in a mole ratio of 5:3 to 100:3. In some embodiments, when the multifunctional silane includes six hydrolyzable groups (e.g., bis(triethoxysilyl)ethane), the ratio can be 10:1 to 200:1. In some embodiments, when the multifunctional silane includes five hydrolyzable groups (e.g., bis(triethoxysilyl)ethane), the ratio can be 8:1 to 160:1. In some embodiments, when the multifunctional silane includes three hydrolyzable groups, the ratio can be 5:1 to 100:1.

In some embodiments, the composition comprises less than 1 weight percent, for example less than 0.5 weight percent, for example less than 0.1 weight percent of a fluorinated organosilane. Preferably, the composition is devoid of a fluorinated organosilane.

In addition to the silicon-containing compound and the multifunctional silane, the compositions of the present disclosure further comprise an acid. The acid can be an organic acid, a mineral acid, or a combination thereof. Exemplary mineral acids can include sulfuric acid, hydrochloric acid, phosphoric acid, sulfonic acids, hydrobromic acid, or a combination thereof. Exemplary organic acids can include acetic acid, formic acid, benzoic acid, or a combination thereof. In an embodiment, the acid is sulfuric acid. In some embodiments, the acid is present in the composition in an amount of 1 to 25 weight percent, for example, 1 to 20 weight percent, for example, 3 to 10 weight percent, based on the weight of the silicon-containing compound.

In an embodiment, the composition comprises the silicon-containing compound in an amount of 50 to 90 weight percent, the multifunctional silane in an amount of 7 to 40 weight percent, and the acid in an amount of 3 to 10 weight percent, wherein weight percent is based on the total weight of the silicon-containing compound, the multifunctional silane, and the acid, and weight percent is based on the weight of the silicon-containing compound. In some embodiments, the composition is a homogenous liquid.

The composition of the present disclosure can further comprise a solvent. The solvent can be one that can dissolve the silicon-containing compound, the multifunctional silane, and the acid, and can be uniformly applied to a surface of a substrate. In some embodiments, the solvent is miscible with water. The solvent can be an organic solvent, for example a C₁-C₆ aliphatic alcohol (e.g., methanol, ethanol, isopropanol, and combinations thereof); a ketone (e.g., acetone, methyl ethyl ketone, and the like); an ester (e.g., ethyl acetate, methyl formate, and the like); an ether (e.g., diethyl ether, diisopropyl ether, methyl t-butyl ether, dipropylene glycol monomethyl ether (DPM), tetrahydrofuran, and the like); hydrocarbon solvents (e.g., alkanes including heptane, decane, hexane, cyclohexane and other paraffinic solvents); and combinations comprising any of the foregoing. In some embodiments, when a combination of solvents is used, at least one of the solvents can be miscible with water. In some embodiments, the solvent is isopropanol, acetone, methanol, ethanol, tetrahydrofuran, dimethyl sulfoxide, toluene, xylene, hexane, cyclohexane or a combination thereof. In some embodiments, the solvent can be used in an amount to provide a solution of about 1 to 50 weight percent, or 5 to 25 weight percent, or 5 to 15 weight percent of the active ingredients, based on the total weight of the active ingredients and the solvent. The term “active ingredients” as used herein refers to the silicon-containing compound, the multifunctional silane, and the acid.

In some embodiments, at least a portion of the multifunctional silane has reacted with at least a portion of the silicon-containing compound. Without wishing to be bound by theory, at least a portion of the multifunctional silane can react with at least a portion of the silicon-containing compound to provide —Si—O—Si— bonds, for example by condensation of hydroxysilyl groups. Hydroxysilyl groups can form as a result of hydrolysis of the hydrolyzable groups.

An article represents another aspect of the present disclosure, wherein the article comprises a coating comprising the above-described composition disposed on a surface of the article. The coating can be crosslinked or uncrosslinked. For example, in some embodiments, at least a portion of the multifunctional silane has reacted with at least a portion of the silicon-containing compound. Similarly, in some embodiments, at least a portion of the multifunctional silane and/or at least a portion of the silicon-containing compound have reacted with at least a portion of the surface of the article (e.g., by physically or chemically bonding to a hydroxyl group on a glass surface). The coating can have improved hydrolytic stability and thermal stability compared to a coating prepared from compositions not including the multifunctional silane.

The coating comprising the composition can have a thickness of 1 to 1000 nanometers. The article can further optionally comprise one or more additional layers, wherein the additional layers can include, for example, a primer layer, a topcoat layer, or a combination thereof. In some embodiments, a primer layer, a topcoat layer, or a combination thereof is excluded, and the coating is disposed directly on a surface of the article.

The above-described composition can provide a durable liquid-repellent coating to various articles for various applications. Exemplary articles that can benefit from application of a coating comprising the composition of the present disclosure can include a window (e.g., a car window, a building window, an airplane window, and the like), a windshield, a glass-containing mirror, a glass-containing lens, cooking utensils, consumer electronics, glassware (e.g., laboratory glassware), medical equipment (e.g., surgical instruments), and the like.

A liquid-repellent article can be prepared according to a method comprising applying the composition comprising the silicon-containing compound, the multifunctional silane, and the acid to a surface of a substrate to form a coating. In some embodiments, a liquid drop on the liquid repellent coated article has low contact angle hysteresis, for example less than or equal to 35°, for example less than or equal to 20°, for example less than or equal to 15°, for example less than or equal to 10°, for example less than or equal to 5°. As used herein, the term “contact angle hysteresis” is defined as the difference between the advancing contact angle and the receding contact angle of the liquid drop. In some embodiments, the liquid drop can be water, an organic solvent, an oil (e.g., petroleum oil, vegetable oil, mineral oil, essential oils, and the like), and the like, or a combination thereof. In some embodiments, the liquid repellent coated article can repel a liquid comprising water, ethylene glycol, hexadecane, n-hexane, oil, blood, or a combination thereof. In some embodiments, the liquid repellent article repels water. In some embodiments, the liquid repellent article repels water, and a liquid drop on the coated surface has an advancing water contact angle of greater than or equal to 90°, for example, greater than or equal to 100°. In some embodiments, the liquid repellent coated article can repel ice.

Suitable substrates can comprise a single material or a combination of materials, and can further be homogenous or heterogeneous in nature. In some embodiments, the surface of the substrate can preferably have high oxygen content, surface hydroxyl groups, or a combination thereof. Useful substrates can include those that comprise glass, minerals, polymers (e.g., polyester, polycarbonate, polyacrylate, and the like), metals (e.g., copper, silver, aluminum, iron, chromium, stainless steel, nickel, and the like), metal alloys, metal oxides, and combinations thereof. In some embodiments, the surface includes glass, silica, alumina, and surfaces having a high oxygen content (e.g., a surface having an oxygen content of about 40% to 80%), and non-glass surfaces including, for example, a ceramic surface, a metal surface (e.g., a metal oxide), or a polymeric surface (e.g., polyester, polycarbonate, polyacrylate, and the like).

Applying the composition can be by, for example, solution coating, spray coating, using a saturated sponge or cloth, or a combination thereof. Applying the composition by solution coating can include methods such as solvent casting, spin coating, drop casting, dip coating, ink jetting, doctor blading, flow coating, and the like. The process of applying the coating can optionally be repeated until the desired coating thickness and/or desired surface coverage is obtained. For example, the composition can preferably be applied to a surface of a substrate by dip coating or spray coating. In some embodiments, application of the composition can be repeated, for example, using a sponge or cloth saturated with the composition. After each application, the coated article can be dried, for example by heating to 50 to 100° C., preferably, 75° C. for 10 to 30 seconds. In some embodiments, the coated article can be rinsed with a solvent, for example, water, to remove excess material (e.g., excess acid).

The invention includes at least the following embodiments.

### Embodiment 1

A composition for preparing a liquid-repellent surface comprising, a silicon-containing compound comprising units of the formula

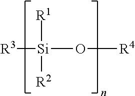

wherein R¹ and R² are independently at each occurrence a substituted or unsubstituted C₁-C₆ alkyl group or a substituted or unsubstituted C₆-C₁₂ aryl group; R³ is a halogen, a hydroxyl, a substituted or unsubstituted C₁-C₆ alkyl group or a hydrolyzable group; R⁴ is hydrogen or a substituted or unsubstituted C₁-C₆ alkyl group or a substituted or unsubstituted C₆-C₁₂ aryl group; and n is 1 to 1500; a multifunctional silane having at least two hydrolyzable groups; and an acid comprising a mineral acid, an organic acid, or a combination thereof.

### Embodiment 2

The composition of embodiment 1, wherein R¹ and R² are independently at each occurrence a substituted or unsubstituted C₁-C₆ alkyl group or C₆-C₁₂ aryl group; wherein R³ is a hydrolyzable group comprising a C₁-C₆ alkoxyl group; wherein R⁴ is a C₁-C₆ alkyl group; and n is 1.

### Embodiment 3

The composition of embodiment 1 or 2, wherein the silicon-containing compound comprises a poly(siloxane), wherein R¹ and R² are independently at each occurrence a substituted or unsubstituted C₁-C₆ alkyl group or C₆-C₁₂ aryl group; wherein R³ is a hydrolyzable group comprising a C₁-C₆ alkoxyl group; wherein R⁴ is a C₁-C₆ alkyl group; and n is greater than 1 to 1500.

### Embodiment 4

The composition of any of embodiments 1 to 3, wherein R¹ and R² are methyl and n is 10 to 250.

### Embodiment 5

The composition of any of embodiments 1 to 4, wherein the multifunctional silane is a silane having the formula X₃₋ₘRₘSiR′SiRₘX₃₋ₘ, X₃₋ₘRₘSiR′NHR′SiRₘX₃₋ₘ, X₃₋ₘRₘSiR′OR′SiRₘX₃₋ₘ, X₃₋ₘRₘSiR′SₚR′SiRₘX₃₋ₘ, X₃₋ₘRₘSiR′SiRₘX₂₋ₘR′SiRₘX₃₋ₘ, SiX₄, RSiX₃, or a combination thereof, wherein m is 0, 1, or 2; p is 1, 2, 3, 4, 5, 6, 7, or 8; each occurrence of R is independently a substituted or unsubstituted C₁-C₆ alkyl group or a substituted or unsubstituted C₆-C₁₂ aryl group; each occurrence of X is independently a hydroxyl or a hydrolysable group comprising a halogen or a C₁-C₆ alkoxyl group; and each occurrence of R′ is independently a divalent substituted or unsubstituted C₁-C₁₂ alkyl group, a divalent substituted or unsubstituted C₁-C₁₂ alkenyl group, a divalent substituted or unsubstituted C₁-C₁₂ alkynyl group.

### Embodiment 6

The composition of any or embodiments 1 to 5, wherein the multifunctional silane comprises dimethyldimethoxysilane, dimethyldiethoxysilane, methyltrimethoxysilane, tetraethoxysilane, bis(methyldimethoxysilyl)ethane, 1-(triethoxysilyl)-2-(diethoxymethylsilypethane, bis(triethoxysilyl)ethane, octaethoxy-1,3,5-trisilapentane, or a mixture thereof.

### Embodiment 7

The composition of any or embodiments 1 to 6, wherein the silicon-containing compound and the multifunctional silane are present in a weight ratio of 1:99 to 99:1.

### Embodiment 8

The composition of any of embodiments 1 to 7, wherein the composition comprises the units of the silicon-containing compound and the hydrolyzable groups of the multifunctional silane in a mole ratio of 5:3 to 100:3.

### Embodiment 9

The composition of any of embodiments 1 to 8, wherein the acid is a mineral acid comprising sulfuric acid, hydrochloric acid, phosphoric acid, a sulfonic acid, hydrobromic acid, or a combination thereof.

### Embodiment 10

The composition of any of embodiments 1 to 9, wherein the acid is an organic acid comprising acetic acid, formic acid, benzoic acid, or a combination thereof.

### Embodiment 11

The composition of any of embodiments 1 to 10, comprising 1 to 25 weight percent of the acid, based on the weight of the silicon-containing compound.

### Embodiment 12

The composition of any of embodiments 1 to 11, further comprising a solvent.

### Embodiment 13

The composition of embodiment 12, wherein the solvent comprises isopropanol, acetone, methanol, ethanol, tetrahydrofuran, dimethyl sulfoxide, toluene, xylene, hexane, cyclohexane, or a combination thereof.

### Embodiment 14

The composition of any of embodiments 1 to 13, wherein at least a portion of the multifunctional silane has reacted with at least a portion of the silicon-containing compound.

### Embodiment 15

The composition of any of embodiments 1 to 14, comprising, 50 to 90 weight percent of the silicon-containing compound comprising poly(dimethylsiloxane); 7 to 40 weight percent of the multifunctional silane comprising methyltrimethoxysilane, 1-(triethoxysilyl)-2-(diethoxymethylsilypethane, bis(triethoxysilyl)ethane, or a combination thereof; and 3 to 10 weight percent of the acid comprising sulfuric acid; wherein weight percent is based on the total weight of the silicon-containing compound, the silane, and the acid.

### Embodiment 16

An article comprising a coating comprising the composition of any of embodiments 1 to 15, wherein at least a portion of the multifunctional silane has reacted with at least a portion of the silicon-containing compound.

### Embodiment 17

The article of embodiment 16, wherein the coating has a thickness of 1 to 1000 nanometers.

### Embodiment 18

The article of any of embodiments 16 or 17, wherein the article is a window, a windshield, a glass-containing mirror, or a glass-containing lens.

### Embodiment 19

A method of preparing a liquid-repellent article, the method comprising applying the composition of any of embodiments 1 to 15 to a surface of a substrate to form a coating.

### Embodiment 20

The method of embodiment 19, wherein applying the composition comprises solution coating, spray coating, using a saturated sponge or cloth, or a combination thereof.

### Embodiment 21

The method of embodiment 19 or 20, wherein the surface comprises glass, a ceramic, a metal, an inorganic oxide, or a polymeric substrate.

### Embodiment 22

The method of any of embodiments 19 to 21, wherein the liquid repellant article repels a liquid comprising water, ethylene glycol, hexadecane, n-hexane, oil, blood, or a combination thereof.

All cited patents, patent applications, and other references are incorporated herein by reference in their entirety, including priority application 62/095,990 filed Dec. 23, 2014. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The invention is further illustrated by the following non-limiting examples.

### EXAMPLES

General Method for Coating a Substrate with a Liquid-Repellent Composition

Substrates were coated either by a dip coating method or by a spray coating method using the compositions prepared according to the examples below. For dip coating, substrates were immersed for 10 seconds at ambient temperature in the solution, withdrawn gradually from the solution, and then placed at ambient temperature for 30 minutes or in an oven operating at 75° C. for 20 seconds, followed by wiping the substrates with a clean cotton cloth or paper towel saturated with the composition and finally rinsing with water to remove excess material. Spray coating was carried out by applying the composition to substrates, then a cotton cloth or paper towel was used to wipe the composition over the substrates uniformly. Substrates were kept at ambient temperature for 30 minutes or in an oven operating at 75° C. for 20 seconds, followed by wiping the substrates with a clean cotton cloth or paper towel saturated with the composition. Comparative Example 3 and Examples 2 and 3 were further rinsed with water to remove excess material (e.g., sulfuric acid).

Liquid-repellent compositions were prepared according to the following procedures.

### Comparative Example 1

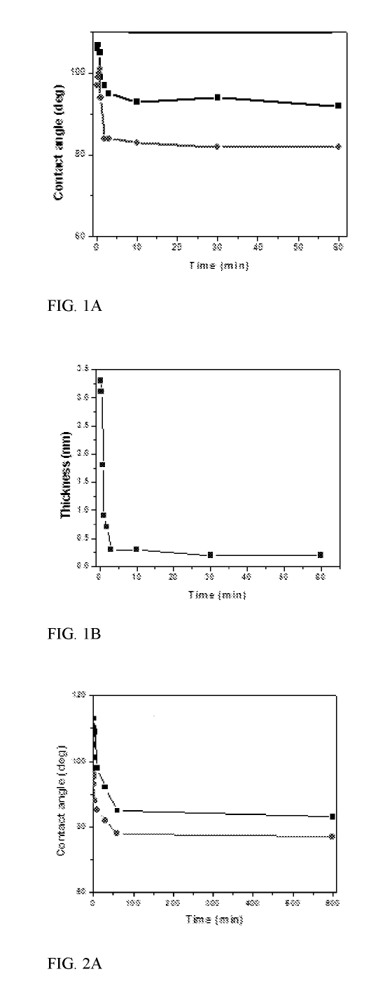

A solution of poly(dimethylsiloxane) (PDMS) having a molecular weight of 9400 Daltons (Da) (5 grams) and sulfuric acid (0.5 grams) in a isopropyl alcohol (60 milliliters) was prepared. Substrates were immersed into the solution for 10 seconds, then heated at 75° C. in oven. The contact angle of the coated substrates was analyzed after heating for a selected period of time (e.g., 10 seconds, 20 seconds, 30 seconds, 50 seconds, 1 minute, 2 minutes, 3 minutes, 10 minutes, 30 minutes, 60 minutes) (FIG. 1A). The thickness of the coating was also determined (FIG. 1B). FIG. 1A shows the advancing (squares) and the receding (circles) contact angles for various heating times for a substrate coated with the composition of Example 1. The advancing contact angle decreased from an initial value of about 106°, to about 95° after about 3 minutes of heating. The advancing contact angle remained at this decreased value with additional heating (up to 60 minutes). The receding contact angle decreased from an initial value of about 99°, to about 84° after about 3 minutes of heating. The receding contact angle changed slightly with additional heating (up to 60 minutes). FIG. 1B shows the change in the thickness of the coating versus heating time. A coating having an initial thickness of about 3.1 nanometers (nm) was reduced to having a thickness of about 0.3 nm after 3 minutes of heating. The changes in contact angle and thickness illustrate the degradation of the coatings when subjected to heat and when sulfuric acid from the casting solution remained in the coating.

### Comparative Example 2

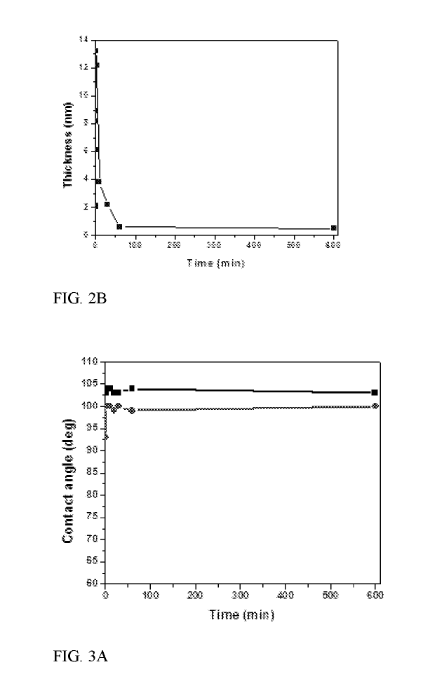

A solution of dimethyldimethoxysilane (5 grams) and sulfuric acid (0.25 grams) was prepared in a isopropyl alcohol (60 milliliters). Substrates were immersed into the solution for 10 seconds, then heated at 75° C. in an oven. Contact angle of the coated substrates was analyzed after heating for a selected period of time (e.g., 20 seconds, 30 seconds, 45 seconds, 1 minute, 2 minutes, 3 minutes,10 minutes, 30 minutes, 60 minutes, 600 minutes) (FIG. 2A) and the thickness of the coating was also determined (FIG. 2B). FIG. 2A shows the advancing (squares) and the receding (circles) contact angles for various heating times for a substrate coated with the composition of Example 2. The advancing contact angle decreased from a value of about 113°, to about 85° after about 1 hour of heating. The advancing contact angle remained the same with additional heating (up to 600 minutes). The receding contact angle decreased from a value of about 95°, to about 78° after about 1 hours of heating. The receding contact angle did not decrease further with additional heating (up to 600 minutes). FIG. 2B shows the change in the thickness of the coating versus heating time. A coating having a thickness of about 13 nm was reduced to a coating having a thickness of about 0.6 nm after 1 hour of heating. The changes in contact angle and thickness illustrate the degradation of the coatings when subjected to heat and when sulfuric acid from the casting solution remained in the coating.

### Example 1

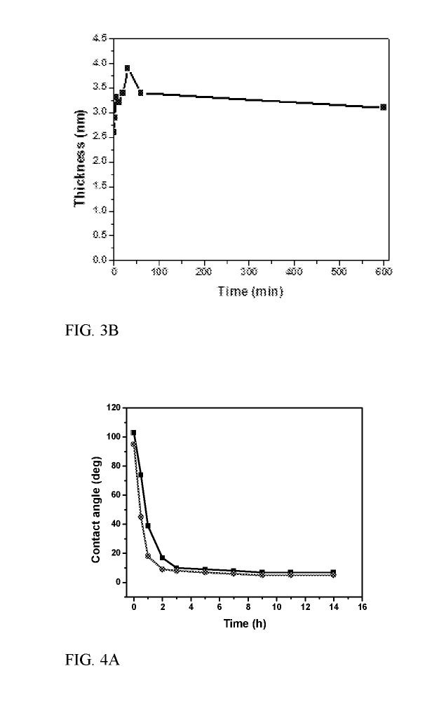

A solution of PDMS having a molecular weight of 9400 Da (5 grams) was prepared by adding to a isopropyl alcohol solution (60 milliliters). Sulfuric acid (0.5 grams) was added. Bis(triethoxysilyl ethane) (1.0 grams) was then added to the solution in an amount of 20 wt. % based on the weight of the PDMS. Substrates were immersed in the solution for 10 seconds, and then heated at 75° C. in oven. Contact angle and thickness of the coatings were analyzed with respect to heating time. FIG. 3A shows an advancing contact angle of about 104° and a receding contact angle of about 100° for substrates coated with the composition of Example 1. FIG. 3A further shows that the substrates retained these contact angles even after extended heating (up to 600 minutes). FIG. 3B shows that the thickness of the coating remained substantially unchanged, having an initial thickness of about 2.6 nm. After 600 minutes of heating at 75° C., the thickness of the coating was about 3.1 nm. Example 1 illustrates that liquid-repellent compositions comprising a siloxane, a multifunctional silane, and an acid are highly durable, and retain their initial liquid-repellency even following heat treatments for extended periods of time. Furthermore, the coatings were highly durable even when small amount of sulfuric acid remained in the coating.

In addition to the increased durability of the coating prepared according to the present invention, the coating of Example 1 also demonstrated improved coatings on surfaces that are typically regarded as less reactive. Water contact angles were thus determined on different substrates (glass, indium tin oxide (ITO), nickel (Ni), titanium (Ti)) treated with the compositions of Comparative Example 1 and Example 1 using the same procedure. The results of this testing is provided in Table 1.

TABLE 1

| | | | Example 1 | |
|---|---|---|---|---|
| | Comparative Example 1 | | | Contact |
| | Contact angle | Contact angle | Contact angle | angle |
| Substrate | (advancing) | (receding) | (advancing) | (receding) |
| Glass | 106° | 92° | 107° | 98° |
| ITO | 67° | 33° | 107° | 95° |
| Ni | 63° | 7° | 106° | 74° |
| Ti | 64° | 6° | 108° | 96° |

Table shows that non-glass substrates coated with the composition of example 1 demonstrate similar liquid-repellent properties as a glass substrate coated with the composition. In contrast, non-glass substrates coated with the composition of Comparative Example 1 showed about a 30-40° decrease in advancing contact angle, and a decrease of 60-85° in receding contact angle.

The coatings prepared according to the present invention further show liquid-repellent properties that extend beyond water to organic solvents having relatively low surface tensions. Coatings prepared from the composition of Example 1 showed “non-stick” properties for various organic solvents, as shown in Table 2.

TABLE 2

| | Surface | | | |
|---|---|---|---|---|
| | tension | | Receding | |
| | (mN/m) | Advancing | contact | Contact angle |
| Solvent | at 20° C. | contact angle | angle | hysteresis |
| Water | 72.80 | 102° | 96° | 6° |
| Ethylene | 47.70 | 80° | 78° | 2° |
| Glycol | | | | |
| Hexadecane | 27.47 | 34° | 33° | 1° |
| n-Hexane | 18.43 | 11° | 10° | 1° |

### Comparative Example 3

A silicon substrate was immersed in a solution of RAIN-X® for 10 seconds. The substrate was then kept under ambient conditions for 30 minutes, and then rinsed and cleaned. The coated substrate was then immersed in boiling water to characterize the hydrolytic stability of the coating.

### Example 2

A solution of poly(dimethylsiloxane) having a molecular weight of 9400 Da (5 grams) was prepared in a isopropyl alcohol (60 milliliters). Sulfuric acid (0.5 grams) was added. 1-(Triethoxysilyl)-2-(diethoxymethylsilyl)ethane (0.75 grams) was then added to the solution. A silicon substrate was immersed in the solution for 10 seconds. The substrate was then kept under ambient conditions for 30 minutes, and then rinsed and cleaned. The coated substrate was then immersed in boiling water to characterize the hydrolytic stability of the coating.

### Example 3

A solution of poly(dimethylsiloxane) having a molecular weight of 9400 Da (5 grams) was prepared in an isopropyl alcohol (60 milliliters). Sulfuric acid (0.5 grams) was added. Methyltrimethoxysilane (0.9 grams) was then added to the solution. A silicon substrate was immersed in the solution for 10 seconds. The substrate was then kept under ambient conditions for 30 minutes, and then rinsed and cleaned. The coated substrate was then immersed in boiling water to characterize the hydrolytic stability of the coating.

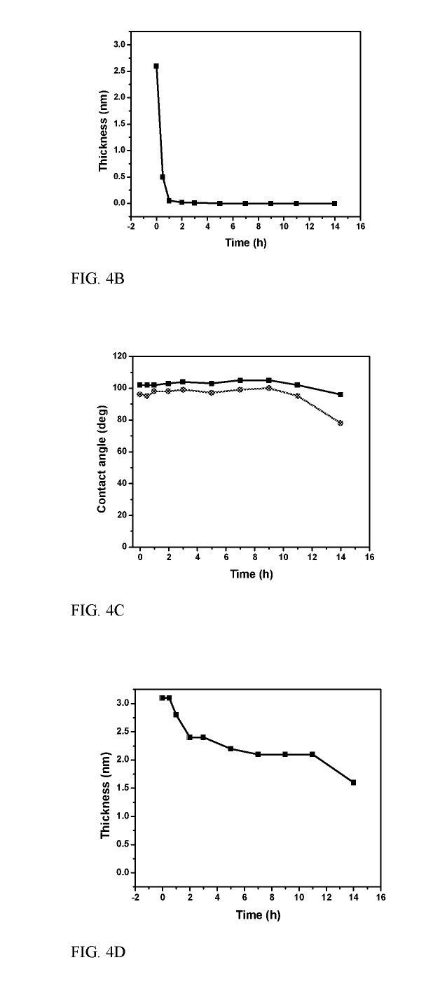

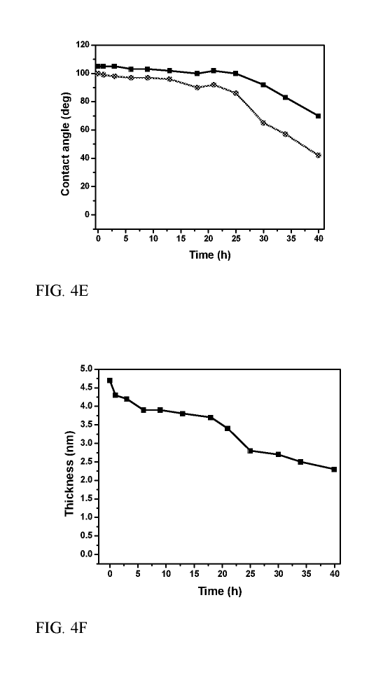

As can be seen in FIG. 4A, FIG. 4B, FIG. 4C, FIG. 4D, FIG. 4E, and FIG. 4F, the hydrolytic stability of the coatings prepared from the compositions of Examples 2 and 3 demonstrated increased hydrolytic stability compared to a silicon substrate coated with the commercially available product known as RAIN-X®. The contact angle of water on the silicon substrate coated with RAIN-X® decreased from about 100° to about 15-20° after 2 hours of immersion in boiling water (FIG. 4A). Furthermore, the thickness measurements indicated that no measureable coating of RAIN-X® was retained on the surface of the substrate after 1 hour of immersion in boiling water (FIG. 4B).

In contrast, coatings prepared from the composition according to Example 2 maintained a contact angle of about 90-100° after 12 hours of immersion in boiling water (FIG. 4C). At 14 hours, a decrease of about 20% was noted in the receding contact angle. Additionally, thickness measurements indicate that the coating of the composition of Example 2 was better maintained compared to that of Comparative Example 3 (FIG. 4D). The coating had an initial thickness of about 3 nm, which was reduced by about 30% after 11 hours, and by about 48% compared to the initial value after 14 hours of immersion in boiling water. FIG. 4E shows a similar trend for the coating prepared according to the composition of Example 3, where the initial contact angle values were maintained for about 13 hours of immersion in boiling water. FIG. 4F shows that the coating was not completely removed as in the case of Comparative example 3, and retained a thickness of about 3.8 nm after 13 hours, and 2.3 nm after 40 hours of immersion in boiling water. These results indicate that the compositions prepared according to the present invention have higher hydrolytic stability compared to compositions not including the siloxane, the multifunctional silane, and an acid. Additionally, modified substrates generally showed improved thermal and hydrolytic stability, while also remaining optically clear.

Materials. Polydimethylsiloxanes having various molecular weights were obtained from Gelest. Methyltrimethoxysilane, 1-(triethoxysilyl)-2-(diethoxymethylsilypethane, bis(triethoxysilyl ethane) were obtained from Gelest. RAIN-X® was obtained from ITW Global Brands and the surface treatment was carried out according to the manufacturer's instructions.

Characterization. Contact angle was determined using a Ramé-Hart telescopic goniometer. Thickness of each of the coatings was determined by a Rudolph research model auto SL-II automatic ellipsometer.

1. A composition for preparing a liquid-repellent surface comprising, a silicon-containing compound comprising units of the formula 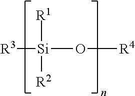
wherein
R¹ and R² are independently at each occurrence a substituted or unsubstituted C₁-C₆ alkyl group or a substituted or unsubstituted C₆-C₁₂ aryl group;
R³ is a halogen, a hydroxyl, a substituted or unsubstituted C₁-C₆ alkyl group or a hydrolyzable group;
R⁴ is hydrogen or a substituted or unsubstituted C₁-C₆ alkyl group or a substituted or unsubstituted C₆-C₁₂ aryl group; and
n is 1 to 1500;
a multifunctional silane having at least two hydrolyzable groups; and
an acid comprising a mineral acid, an organic acid, or a combination thereof.

2. The composition of claim 1,
wherein R¹ and R² are independently at each occurrence a substituted or unsubstituted C₁-C₆ alkyl group or C₆-C₁₂ aryl group;
wherein R³ is a hydrolyzable group comprising a C₁-C₆ alkoxyl group;
wherein R⁴ is a C₁-C₆ alkyl group; and
n is 1.

3. The composition of claim 1, wherein the silicon-containing compound comprises a poly(siloxane),
wherein R¹ and R² are independently at each occurrence a substituted or unsubstituted C₁-C₆ alkyl group or C₆-C₁₂ aryl group;
wherein R³ is a hydrolyzable group comprising a C₁-C₆ alkoxyl group;
wherein R⁴ is a C₁-C₆ alkyl group; and
n is greater than 1 to 1500.

4. The composition of claim 3, wherein R¹ and R² are methyl and n is 10 to 250.

5. The composition of claim 1, wherein the multifunctional silane is a silane having the formula X₃₋ₘRₘSiR′SiRₘX₃₋ₘ, X₃₋ₘRₘSiR′NHR′SiRₘX₃₋ₘ, X₃₋ₘRₘSiR′OR′SiRₘX₃₋ₘ, X₃₋ₘRₘSiR′SₚR′SiRₘX₃₋ₘ, X₃₋ₘRₘSiR′SiRₘX₂₋ₘR′SiRₘX₃₋ₘ, SiX₄, RSiX₃, or a combination thereof, wherein
m is 0, 1, or 2;
p is 1, 2, 3, 4, 5, 6, 7, or 8;
each occurrence of R is independently a substituted or unsubstituted C₁-C₆ alkyl group or a substituted or unsubstituted C₆-C₁₂ aryl group;
each occurrence of X is independently a hydroxyl or a hydrolyzable group comprising a halogen or a C₁-C₆ alkoxyl group; and
each occurrence of R′ is independently a divalent substituted or unsubstituted C₁-C₁₂ alkyl group, a divalent substituted or unsubstituted C₁-C₁₂ alkenyl group, a divalent substituted or unsubstituted C₁-C₁₂ alkynyl group.

6. The composition of claim 1, wherein the multifunctional silane comprises dimethyldimethoxysilane, dimethyldiethoxysilane, methyltrimethoxysilane, tetraethoxysilane, bis(methyldimethoxysilyl)ethane, 1-(triethoxysilyl)-2-(diethoxymethylsilypethane, bis(triethoxysilyl)ethane, octaethoxy-1,3,5-trisilapentane, or a mixture thereof.

7. The composition of claim 1, wherein the silicon-containing compound and the multifunctional silane are present in a weight ratio of 1:99 to 99:1.

8. The composition of claim 1, wherein the composition comprises the units of the silicon-containing compound and the hydrolyzable groups of the multifunctional silane in a mole ratio of 5:3 to 100:3.

9. The composition of claim 1, wherein the acid is a mineral acid comprising sulfuric acid, hydrochloric acid, phosphoric acid, sulfonic acids, hydrobromic acid, or a combination thereof.

10. The composition of claim 1, wherein the acid is an organic acid comprising acetic acid, formic acid, benzoic acid, or a combination thereof.

11. The composition of claim 1, comprising 1 to 25 weight percent of the acid, based on the weight of the silicon-containing compound.

12. The composition of claim 1, further comprising a solvent, wherein the solvent comprises isopropanol, acetone, methanol, ethanol, tetrahydrofuran, dimethyl sulfoxide, toluene, xylene, hexane, cyclohexane, or a combination thereof.

13. The composition of claim 1, wherein at least a portion of the multifunctional silane has reacted with at least a portion of the silicon-containing compound.

14. The composition of claim 1 comprising,
50 to 90 weight percent of the silicon-containing compound comprising poly(dimethylsiloxane);
7 to 40 weight percent of the multifunctional silane comprising methyltrimethoxysilane, 1-(triethoxysilyl)-2-(diethoxymethylsilyl)ethane, bis(triethoxysilyl)ethane, or a combination thereof; and
3 to 10 weight percent of the acid comprising sulfuric acid;
wherein weight percent is based on the total weight of the silicon-containing compound, the silane, and the acid.

15. An article comprising a coating comprising the composition of claim 1, wherein at least a portion of the multifunctional silane has reacted with at least a portion of the silicon-containing compound.

16. The article of claim 15, wherein the coating has a thickness of 1 to 1000 nanometers.

17. The article of claim 15, wherein the article is a window, a windshield, a glass-containing mirror, or a glass-containing lens.

18. A method of preparing a liquid-repellent article, the method comprising applying the composition of claim 1 to a surface of a substrate to form a coating.

19. The method of claim 18, wherein applying the composition comprises solution coating, spray coating, using a saturated sponge or cloth, or a combination thereof.

20. The method of claim 18, wherein the surface comprises glass, a ceramic, a metal, an inorganic oxide, or a polymeric substrate.
